(19) United States
(12) Patent Application Publication
(10) Pub. No.: US 2011/0172880 A1
(43) Pub. Date: Jul. 14, 2011

(54) AIR CONDITIONING CONTROL DEVICE AND AIR CONDITIONING CONTROL METHOD

(75) Inventor: Yuichi Tamura, Kawagoe (JP)

(73) Assignee: PIONEER CORPORATION, KANAGAWA (JP)

(21) Appl. No.: 13/063,471

(22) PCT Filed: Sep. 26, 2008
(86) PCT No.: PCT/JP2008/067434

§ 371 Date: Mar. 11, 2011

(51) Int. Cl. B60H 1/00; B60H 1/32

(52) U.S. Cl. 701/36

(57) ABSTRACT

A prediction element predicts a predicted arrival time at a destination based on a travel route found by a search element. In normal control mode, the first learning element learns the time period from the time point at which a vehicle is stopped, until an air-based on the predicted arrival time and the result of the learning, a control element estimates a linger period from the present moment until the passenger leaves the passenger compartment after arrival, and, based on the temperatures inside the passenger compartment and the outside as detected by first and second temperature detection element and temperature transition time information, specifies a divergence period from stopping the air-conditioning device until the temperature inside the passenger compartment leaves a comfortable temperature range. The control element stops the air-conditioning device automatically when it is decided that the linger period has become not lager than the divergence period.

### TECHNICAL FIELD

The present invention relates to an air conditioning control device, to an air conditioning control method, to an air conditioning control program, and to a recording medium upon which that air conditioning control program is recorded.

### BACKGROUND ART

From the past, in order to ensure comfort within the passenger compartment of a vehicle, vehicles have generally been provided with air conditioning devices (i.e. with so-called automobile air conditioners). Since the electrical power consumed by such an automobile air conditioner is large, in order to be able to expect enhancement of the fuel consumption of the vehicle and reduction of use of the battery of the vehicle and so on, it is necessary to reduce the consumption of electrical power by the automobile air conditioner.

In order to cope with this necessity, a technique has been proposed for controlling the operation of an automobile air conditioner according to the operational mode of the vehicle as selected by the driver or the like (refer to Patent Document #1, hereinafter referred to as the “prior art”). With the technique of this prior art example, there are provided an operational mode in which engine control is performed while giving priority to the performance of the vehicle (i.e. to power performance), and an operational mode in which engine control is performed while giving priority to economical fuel consumption. When the operational mode in which priority is given to energy saving (hereinafter termed the “energy saving control mode”) is set by the driver or the like, it is arranged to suppress consumption of electrical power by the automobile air conditioner by always keeping the automobile air conditioner stopped.

Patent Document #1: Japanese Laid-Open Patent Publication 2008-6993.

### DISCLOSURE OF THE INVENTION

### Problems to be Solved by the Invention

With the technique of the prior art example described above, when the energy saving control mode is selected as the operational mode by the driver or the like, simply the automobile air conditioner is stopped. Due to this, during operation in the energy saving control mode, negative influences are experienced from the environmental temperature exterior to the vehicle passenger compartment: for example during the summer the temperature within the passenger compartment rises to an uncomfortable temperature, while during the winter the temperature within the passenger compartment drops to an uncomfortable temperature.

Due to this, a technique has been eagerly anticipated that can reconcile maintaining the comfort from the point of view of the vehicle passengers, and reduction of the amount of electrical power consumed by the air conditioning device. Responding to this requirement is one of the problems which the present invention applies itself to solve.

The present invention has been conceived in consideration of the circumstances described above, and it takes as its object to provide an air conditioning control device and an air conditioning control method that are capable of reducing the amount of electrical power consumed by an air conditioning device, while maintaining comfort in the interior of the vehicle passenger compartment.

### Means for Solving The Problems

According to a first aspect thereof, the present invention is an air conditioning control device, mounted to a vehicle, which controls the operation of an air conditioning device that regulates the temperature inside a passenger compartment, characterized by comprising: a first temperature detection means that detects said temperature inside the passenger compartment; a second temperature detection means that detects the temperature external to the passenger compartment of said vehicle; a prediction means that obtains a predicted arrival time of said vehicle at a destination; a storage means that stores temperature transition time information consisting of the time period required until said temperature inside the passenger compartment deviates from a predetermined comfortable temperature range, corresponding to the temperature inside the passenger compartment and the temperature external to the passenger compartment when said air conditioning device is stopped; and a control means that performs automatic stop control to stop said air conditioning device, at the time point that it is decided that said temperature inside the passenger compartment will not deviate from said comfortable temperature range even if said air conditioning device is stopped, over an interval that it is estimated that a passenger will remain within the passenger compartment of said vehicle, while taking into consideration said predicted arrival time, said temperature inside the passenger compartment, said temperature external to the passenger compartment, and said temperature transition time information.

According to a second aspect thereof, the present invention is an air conditioning control method employed by an air conditioning control device that is mounted to a vehicle, and that controls the operation of an air conditioning device that regulates the temperature inside a passenger compartment, characterized by comprising: a temperature detection process of detecting said temperature inside the passenger compartment and the temperature external to the passenger compartment of said vehicle; a prediction process, performed in parallel with said temperature detection process, of obtaining a predicted arrival time of said vehicle at a destination; and an automatic stop control process of stopping the operation of said air conditioning device, at the time point that it is decided that said temperature inside the passenger compartment will not deviate from said comfortable temperature range even if said air conditioning device is stopped, over an interval that it is estimated that a passenger will remain within the passenger compartment of said vehicle, while taking into consideration said predicted arrival time, said temperature inside the passenger compartment and said temperature external to the passenger compartment, and temperature transition time information consisting of the time period required until said temperature inside the passenger compartment deviates from a predetermined comfortable temperature range, stored in a storage means provide to said air conditioning control device, and corresponding to the temperature inside the passenger compartment and the temperature external to the passenger compartment when said air conditioning device is stopped.

Furthermore, according to a third aspect thereof, the present invention is an air conditioning control program, characterized in that it causes a calculation means to execute an air conditioning control method according to the present invention.

Moreover, according to a fourth aspect thereof, the present invention is a recording medium, characterized in that an air conditioning control program according to the present invention is recorded thereupon so as to be readable by a calculation means.

### BRIEF DESCRIPTION OF THE DRAWINGS

FIG. 1 schematically shows the structure of an air conditioning control device according to the first embodiment of the present invention;

FIG. 2 schematically shows the structure of an air conditioning control device according to the second embodiment of the present invention;

FIG. 3 schematically shows the structure of a navigation device according to an example of the present invention;

FIG. 4 is used for explanation of the details of temperature transition time information (TTI) in FIG. 3;

FIG. 5A is used for explanation of temperature transition time periods (the first part thereof);

FIG. 5B is used for explanation of temperature transition time periods (the second part thereof);

FIG. 6 is used for explanation of learning result information (SRI) of the navigation device of FIG. 3;

FIG. 7 is a flow chart for explanation of learning processing performed by the navigation device of FIG. 3;

FIG. 8 is a flow chart for explanation of automatic stop control processing performed by the navigation device of FIG. 3;

FIG. 9 is used for explanation of the timing at which this automatic stop control processing is performed by the navigation device of FIG. 3;

FIG. 10 is used for explanation of a variant example of the automatic stop control procedure; and

FIG. 11 is a flow chart for explanation of updating processing in a variant example of performing updating of the temperature transition time information.

### BEST MODE FOR CARRYING OUT THE INVENTION

In the following, embodiments of the present invention will be explained with reference to the appended drawings. It should be understood that, in the following explanation, elements that are the same as or equivalent are denoted by the same reference symbols, and duplicated explanation is omitted.

### The First Embodiment

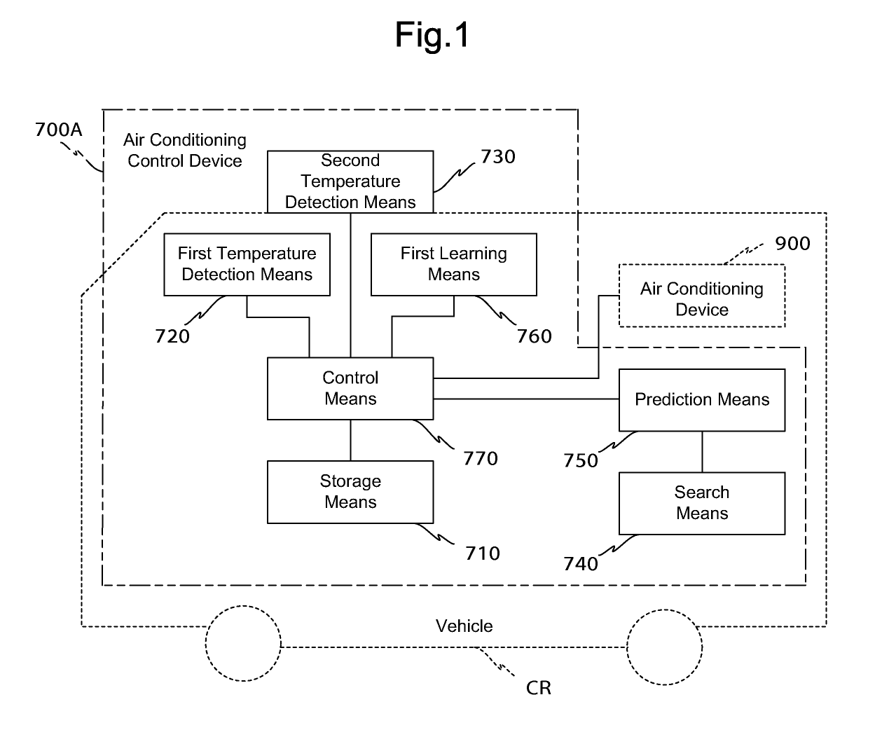

First, an air conditioning control device 700A that is the first embodiment of the present invention will be explained with reference to FIG. 1. This air conditioning control device 700A is mounted to a vehicle CR, and is adapted to control the operation of an air conditioning device 900 that performs adjustment of the temperature inside the vehicle passenger compartment.

<Structure>

In FIG. 1, the schematic structure of the air conditioning control device 700A is shown as a block diagram. As shown in FIG. 1, this air conditioning control device 700A comprises a storage means 710, a first temperature detection means 720, and a second temperature detection means 730. Moreover, the air conditioning control device 700A comprises a search means 740 and a prediction means 750. Furthermore, the air conditioning control device 700A comprises a first learning means 760 and a control means 770.

The storage means 710 described above includes a non-volatile rewritable storage region. The control means 770 is able to access this storage means 710.

It is arranged for temperature transition time information to be stored in this storage region of the storage means 710, related to the time periods required for the temperature inside the passenger compartment to deviate from a predetermined comfortable temperature range, corresponding to the temperature inside the passenger compartment of the vehicle CR and the temperature external to the passenger compartment when the operation of the air conditioning device 900 is stopped. In this first embodiment, it is arranged for this “temperature transition time information” to be determined in advance on the basis of experiment, simulation, and so on.

It should be understood that it would be acceptable to arrange to determine the “predetermined comfortable temperature range” in advance on the basis of experience and so on, or it would also be acceptable to arrange for setting thereof to be performed by the user. Here if setting by the user is performed, then, at the time point that this setting is performed, the “temperature transition time information” is selected from among a number of temperature transition time information candidates prepared in advance in correspondence to various combinations of temperature inside the passenger compartment and temperature outside the passenger compartment.

The first temperature detection means 720 described above incorporates a temperature sensor, and detects the temperature inside the passenger compartment. The temperature inside the passenger compartment that has thus been detected by the first temperature detection means 720 is sent to the control means 770.

The second temperature detection means 730 described above incorporates a temperature sensor, and detects the temperature external to the passenger compartment. The temperature external to the passenger compartment that has thus been detected by the second temperature detection means 730 is sent to the control means 770.

It should be understood that the second temperature detection means 730 may be adapted to detect the external air temperature, as being the temperature external to the passenger compartment.

The search means 740 described above searches for a travel route for the vehicle CR to its destination. Here, the destination is set by the user. The search means 740 refers to map data and so on, and thus finds a travel route to the set destination. The result of searching by the search means 740 is sent to the prediction means 750.

The prediction means 750 described above obtains a predicted arrival time at the destination on the basis of the travel route found by the search means 740, and in consideration of traveling information such as the driving speed of the vehicle CR and so on. This predicted arrival time predicted by the prediction means 750 is sent to the control means 770.

When a control procedure for an energy saving control mode that will be described hereinafter is not being performed by the control means 770, the first learning means 760 described above performs first learning processing, which consists of learning the time period from the time point that the vehicle CR arrives at its destination or the time point that the vehicle CR stops, to when the air conditioning device 900, which was in operation, is stopped. By performing this first learning processing, the first learning means 760 learns the linger period during which the passenger or passengers within the vehicle CR stay within the vehicle passenger compartment, after the vehicle CR arrives at its destination and has been stopped. The result of this first learning processing by the first learning means 760 is sent to the control means 770.

During this first learning processing, it may be arranged for the first learning means 760 to perform learning while distinguishing, at the time point that the vehicle CR arrives at its destination or the vehicle CR stops, whether the air conditioning device 900 is performing passenger compartment heating operation or is performing air conditioning operation. By performing learning while distinguishing between passenger compartment heating operation and air conditioning operation in this manner, the individual preference of the passenger within the vehicle CR for warmth or coolness is reflected, and it is possible to learn the linger period of the passengers within the vehicle passenger compartment after arrival at the destination.

Furthermore, during this first learning processing, it may be arranged for the first learning means 760 to perform learning for each temperature external to the passenger compartment detected by the second temperature detection means 730. By thus performing learning for each temperature external to the passenger compartment, it is possible to learn the linger period of the passengers within the vehicle passenger compartment after arriving at the destination, while reflecting the tendencies of the individual behavior of the passengers in the vehicle CR as corresponding to the difference between the temperature external to the passenger compartment and a comfortable temperature.

The control means 770 described above performs control procedure to control the operation of the air conditioning device 900 in either a normal control mode or an energy saving control mode, according to setting by a vehicle passenger. In the normal control mode, the control means 770 performs starting control and stop control of the air conditioning device 900 and performs control for designating a target temperature for regulation, according to commands from the passenger. It should be understood that, during normal control mode operation, the control means 770 reports to the first learning means 760 the fact that stop control has been performed.

On the other hand, in the energy saving control mode, in addition to the control according to settings by the passenger as described above, on the basis of (i) the predicted arrival time at the destination received from the prediction means 750, (ii) the result of the first learning processing received from the first learning means 760, (iii) the temperature inside the passenger compartment detected by the first temperature detection means 720, (iv) the temperature external to the passenger compartment detected by the second temperature detection means 730, and (v) the temperature transition time information stored in the storage means 710, the control means 770 performs automatic stop control to stop the air conditioning device at the time point that the control means 770 decides that the temperature inside the passenger compartment will not deviate to outside the comfortable temperature range even if operation of the air conditioning device 900 is stopped, during the interval that the control means 770 estimates that the passenger will stay within the passenger compartment of the vehicle CR. The details of the processing for this automatic stop control will be described hereinafter.

It should be understood that it may be arranged for the control means 770, before this automatic stop control, to perform setting of the temperature inside the passenger compartment by regulation with the air conditioning device 900 stepwise within the comfortable temperature range along the direction of change of the temperature inside the passenger compartment when the operation of the air conditioning device 900 is stopped.

### <Operation>

Next, the operation of this air conditioning control device 700A having the structure described above will be explained, with attention being principally directed to the control procedure for the air conditioning device 900 during the energy saving control mode.

### <<The First Learning Processing>>

First, the first learning processing in the normal control mode described above related to the time period from the time point that the vehicle CR arrives at its destination or the time point that the vehicle CR stops, to when the air conditioning device 900, which was in operation, is stopped, will be explained. The result of this first learning processing is utilized in the energy saving control mode described above for automatic stop control of the air conditioning device 900.

During the first learning processing, in the normal control mode, the first learning means 760 makes a judgment as to whether or not the vehicle has arrived at its destination or has stopped. If the result of this judgment is affirmative then the first learning means 760 starts to time the interval until, without the vehicle leaving from the destination or starting off, the operation of the air conditioning device 900 is stopped. This stopping of the air conditioning device 900 may be stopping of the air conditioning device 900 that is performed in response to a stop command issued to the control means 770 by the passenger, or stopping of the air conditioning device 900 along with an accessory power supply being turned off due to operation of the engine key by the passenger (i.e. the driver).

When, in this manner, a new timing result is obtained relating to the time interval from the time point that the vehicle CR arrives at its destination or the time point that the vehicle CR stops, to when the air conditioning device 900, which was in operation, is stopped, then the first learning means 760 calculates the result of this new first learning processing on the basis of results of first learning processing up until now that are stored internally, and this new timing result. The result of this new first learning processing that has been calculated in this manner is sent to the control means 770, along with being stored internally to the first learning means 760.

During this calculation of the result of the new first learning processing, if no results of first learning processing up until the present are stored internally to the first learning means 760, then the first learning means 760 employs the new timing result just as it is as the result of this new first learning processing. Moreover, if some results of first learning processing up until the present are stored internally to the first learning means 760, then it may be arranged for the first learning means 760 to, for example, calculate the result of this new first learning processing by calculating a weighted average of this new timing result and the results of first learning processing up until the present.

It should be understood that it is arranged for the first learning means 760 to be able, during this first learning processing as described above, to learn while distinguishing, at the time point that the vehicle CR arrived at its destination or the time point that the vehicle CR stopped, whether the air conditioning device 900 was performing passenger compartment heating operation or was performing air conditioning operation. Furthermore, during this first learning processing, the first learning means 760 may also be adapted to perform learning for each temperature external to the passenger compartment detected by the second temperature detection means 730.

### <<The Control Procedure in the Energy Saving Control Mode>>

Next, the control procedure of this first embodiment in the energy saving control mode will be explained, with attention being principally directed to the processing for automatic stop control of the air conditioning device 900 by the control means 770.

It should be understood that it will be supposed that the vehicle CR is traveling upon a travel route that has been found by the search means 740. Furthermore, it will be supposed that the prediction means 750 executes prediction processing for a predicted arrival time at the destination on the basis of the travel route that has been found, while taking into consideration traveling information such as the driving speed of the vehicle CR and so on, and that, each time a new predicted arrival time is obtained, this new predicted arrival time is reported to the control means 770.

In the energy saving control mode, the control means 770 estimates the linger period from the present time point until the passengers leave the passenger compartment of the vehicle CR that has arrived at the destination, on the basis of the predicted arrival time at the destination from the prediction means 750, and the result of the first learning processing from the first learning means 760. Furthermore, the control means 770 specifies a divergence period, which is the time period from when the operation of the air conditioning device 900 is stopped until the temperature inside the passenger compartment deviates outside the comfortable temperature range, on the basis of the temperature inside the passenger compartment detected by the first temperature detection means 720, the temperature external to the passenger compartment detected by the second temperature detection means 730, and the temperature transition time information stored in the storage means 710.

When estimation of the linger period and specification of the divergence period have been performed in this manner, then the control means 770 makes a judgment as to whether or not the linger period has become less than or equal to the divergence period. If the result of this judgment is negative, then the control means 770 repeats the processing described above. In parallel with this repeated processing, the control means 770 also performs starting control and stop control of the air conditioning device 900 in accordance with commands from the passenger, and control to designate a target temperature for regulation. On the other hand, at the time point that the result of the above judgment becomes affirmative, the control means 770 performs automatic stop control to stop the air conditioning device 900.

It should be understood that it may also be arranged for the control means 770, before performing automatic stop control, to perform setting regulation of the temperature inside the passenger compartment with the air conditioning device 900 stepwise within the comfortable temperature range along the direction of change of the temperature inside the passenger compartment when the air conditioning device 900 has been stopped. If this type of setting regulation of the temperature inside the passenger compartment stepwise before the automatic stop control is more advantageous from the point of view of energy saving that abrupt automatic stop control, then it is performed according to a predetermined algorithm. This “predetermined algorithm” is obtained in advance on the basis of experiment, simulation, experience, and so on.

As has been explained above, in this first embodiment, the prediction means 750 obtains the predicted arrival time at the destination on the basis of the travel route that has been found by the search means 740, while taking into consideration traveling information such as the driving speed of the vehicle CR and so on. Moreover, in the normal control mode, the first learning means 760 performs the first learning processing in relation to the time interval from the time point that the vehicle CR arrives at its destination or the time point that the vehicle CR stops, to when the air conditioning device 900, which was in operation, is stopped.

In the energy saving control mode, the control means 770 estimates the linger period from the present time point until the passengers leave the passenger compartment of the vehicle CR that has arrived at the destination, on the basis of the above predicted arrival time and the results of the first learning processing. Moreover, the control means 770 specifies the divergence period, that is the time interval taken from when the operation of the air conditioning device 900 is stopped until the temperature inside the passenger compartment to deviate from the comfortable temperature range, on the basis of the temperature inside the passenger compartment detected by the first temperature detection means 720, the temperature external to the passenger compartment detected by the second temperature detection means 730, and the temperature transition time information stored in the storage means 710. At the time point that it has been decided that the above linger period has become less than or equal to the above divergence period, automatic stop control is performed and the operation of the air conditioning device 900 is stopped.

Thus, according to this first embodiment, it is possible to reduce the amount of electrical power consumed by the air conditioning device while maintaining the comfort within the vehicle passenger compartment.

### The Second Embodiment

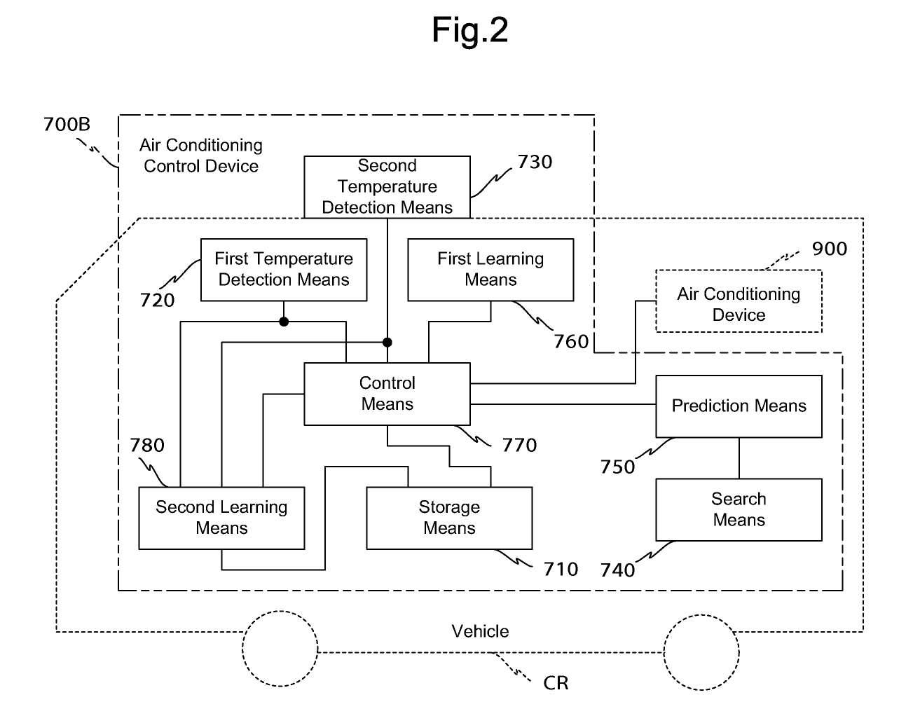

First, an air conditioning control device 700B according to the second embodiment of the present invention will be explained with reference to FIG. 2. This air conditioning control device 700B also is mounted to a vehicle CR, and is adapted to control the operation of an air conditioning device 900, in a similar manner to the case with the air conditioning control device 700A of the first embodiment described above.

### <Structure>

The schematic structure of this air conditioning control device 700B is shown in FIG. 2 as a block diagram. As shown in FIG. 2, the only way in which the air conditioning control device 700B differs from the air conditioning control device 700A described above is that it additionally comprises a second learning means 780. In the following, the explanation will principally concentrate upon this point of difference.

The second learning means 780 described above performs a second learning processing procedure, which consists of learning the relationship after the air conditioning device 900 has been stopped between the temperature inside the passenger compartment and the temperature external to the passenger compartment. For this second learning processing, the fact that stop control of the operation of the air conditioning device 900 has been performed in response to a stop command issued by the passenger is reported from the control means 770 to the second learning means 780.

Upon receipt of this report, the second learning means 780 thereafter performs second learning on the basis of the temperature inside the passenger compartment detected by the first temperature detection means 720 and the temperature external to the passenger compartment detected by the second temperature detection means 730. On the basis of the new second learning processing result obtained by this second learning process, the second learning means 780 updates the temperature transition time information stored in the storage means 710.

### <Operation>

Next, the operation of this air conditioning control device 700B having the structure described above will be explained, with attention principally being directed to the second learning processing and to the utilization of the results of this second learning processing.

### <<The Second Learning Processing>>

Before the second learning processing, irrespective of whether this is during the normal control mode or during the energy saving control mode, the second learning means 780 makes a judgment as to whether or not it has been reported from the control means 770 that stop control of the operation of the air conditioning device 900 has been performed in response to a stop command issued by the passenger. At the time point that the result of this judgment becomes affirmative, the second learning means 780 starts the second learning processing.

When the second learning processing is started in this manner, the second learning means 780 periodically thereafter gathers the temperature inside the passenger compartment detected by the first temperature detection means 720 and the temperature external to the passenger compartment detected by the second temperature detection means 730. This gathering may, for example, be performed until the temperature inside the passenger compartment deviates from the comfortable temperature range described above.

Next, on the basis of the results gathered at this time, the second learning means 780 extracts, for example, a characteristic parameter for change of the temperature in the passenger compartment corresponding to the temperature external to the passenger compartment. On the basis of the characteristic parameter extracted this time and the characteristic parameter that is registered internally to the second learning means 780 at this time point, the second learning means 780 calculates a new characteristic parameter by, for example, calculating the weighted average value thereof, and registers this internally to the second learning means 780. As a result, the characteristic parameter registered internally to the second learning means 780 is updated.

Next, the second learning means 780 calculates new temperature transition time information by utilizing this new characteristic parameter. The second learning means 780 registers this new temperature transition time information in the storage means 710. As a result, the temperature transition time information in the storage means 710 is updated.

### <<The Control Procedure in the Energy Saving Control Mode>>

Next, the control procedure in this second embodiment in the energy saving control mode will be explained.

In this second embodiment, the control procedure in the energy saving control mode is performed in a similar manner to the case in the first embodiment described above. The result thereof, i.e. the result of the second learning by the second learning means 780, comes to be reflected in the specification of the divergence period that is the time interval taken for the temperature inside the passenger compartment to deviate from the comfortable temperature range.

As has been explained above, in this second embodiment, in a similar manner to the case with the first embodiment described above, the prediction means 750 obtains a predicted arrival time at the destination. Furthermore, in a similar manner to the case with the first embodiment, the first learning means 760 performs first learning processing.

Furthermore, the second learning means 780 performs this second learning, which is learning of the relationship between the temperature inside the passenger compartment and the temperature external to the passenger compartment after the air conditioning device 900 is stopped, irrespective of whether the normal control mode or the energy saving control mode is currently in force. The second learning means 780 updates the temperature transition time information in the storage means 710 by utilizing the result of this second learning.

Moreover, in this second embodiment, in a similar manner to the case with the first embodiment described above, in the energy saving control mode, the control means 770 estimates the linger period from the present time point until the passengers leave the passenger compartment of the vehicle CR that has arrived at the destination. The control means 770 specifies the divergence period that is the time interval taken from after the air conditioning device 900 is stopped until the temperature inside the passenger compartment to deviate from the comfortable temperature range. The result is that a divergence period is specified in which the result of the second learning by the second learning means 780 is reflected.

At the time point that it has been decided that this linger period has become less than or equal to the above divergence period, the control means 770 performs automatic stop control to stop the operation of the air conditioning device 900.

Thus, according to this second embodiment, it is possible to reduce the amount of electrical power consumed by the air conditioning device, while maintaining the comfort within the vehicle passenger compartment with better accuracy than in the case of the first embodiment.

It should be understood that it would also be possible to arrange to constitute the air conditioning control devices 700A and 700B of the first and second embodiments described above by providing a computer that serves as a calculation means, and to implement the functions of the various means described above by executing programs, with the exception of those of the storage means 710 and the first and second temperature detection means 720 and 730. It would be acceptable to arrange for these programs to be acquired in the format of being recorded upon a transportable recording medium such as a CD-ROM, a DVD, or the like; and it would also be acceptable to arrange for them to be acquired in the format of being transmitted via a network such as the internet or the like.

### EXAMPLES

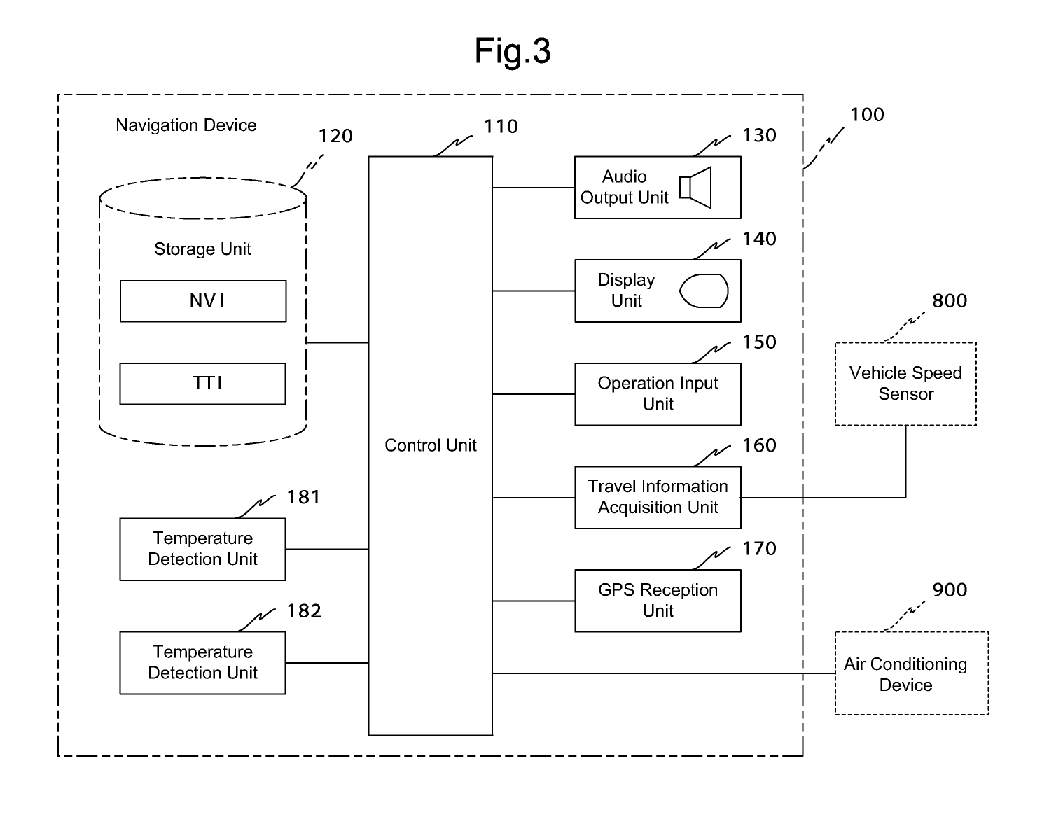

In the following, an example of the navigation device of the present invention will be explained with reference principally being made to FIGS. 3 through 9. It should be understood that, in the following explanation and drawings, the same reference symbols will be appended to elements that are the same or equivalent, and duplicated explanation will be omitted.

The schematic structure of a navigation device 100 having the function of an air conditioning control device according to an example is shown in FIG. 3. It should be understood that one function of this navigation device 100 is to operate as the air conditioning control device 700A of the first embodiment described above (refer to FIG. 1), and it is mounted to a vehicle CR and controls the operation of an air conditioning device 900 that performs regulation of the temperature inside the vehicle passenger compartment. Moreover, a vehicle speed sensor 800 that is mounted to the vehicle CR separately from this navigation device 100 is connected to the navigation device 100.

### [Structure]

As shown in FIG. 3, this navigation device 100 comprises a control unit 110 and a storage unit 120 which functions as the storage means 710. Moreover, the navigation device 100 comprises an audio output unit 130, a display unit 140, and an operation input unit 150. The navigation device 100 further comprises a travel information acquisition unit 160 and a GPS (Global Positioning System) reception unit 170. Yet further, the navigation device 100 comprises a temperature detection unit 181 that functions as the first temperature detection means 720 and a temperature detection unit 182 that functions as the second temperature detection means 730.

The control unit 110 described above controls the navigation device 100 as a whole. This control unit 110 will be described hereinafter.

The storage unit 120 described above is a non-volatile storage device, and consists of a hard disk device or the like. This storage unit 120 stores various types of data, such as information for navigation (NVI) and temperature transition time information (TTI) and so on. The control unit 110 is adapted to be able to access the storage unit 120.

Various types of data utilized for navigation, such as map data, POI (Points of Interest) data, background data and so on, are stored in the information for navigation described above.

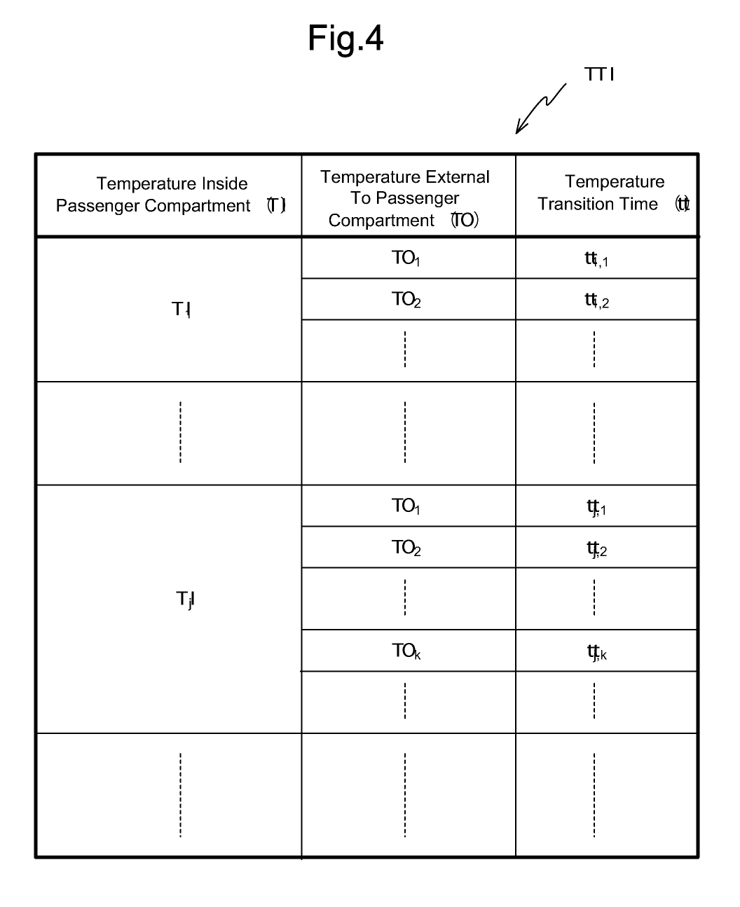

As shown in FIG. 4, the temperature transition time information described above is temperature transition time periods tt_{j, k}, which are the time periods required for the temperature inside the passenger compartment to deviate from the predetermined comfortable temperature range due to experiencing the influence of the temperature external to the passenger compartment, in correspondence with combinations of temperature inside the passenger compartment (TIⱼ (j=1, 2, . . . )) that are within a predetermined comfortable temperature range at the time point that the air conditioning device 900 which was in operation is stopped, and temperature external to the passenger compartment (TOₖ (k=1, 2, . . . )) that are outside the predetermined comfortable temperature range. Here, the “predetermined comfortable temperature range” is determined in advance on the basis of experiment, experience, or the like.

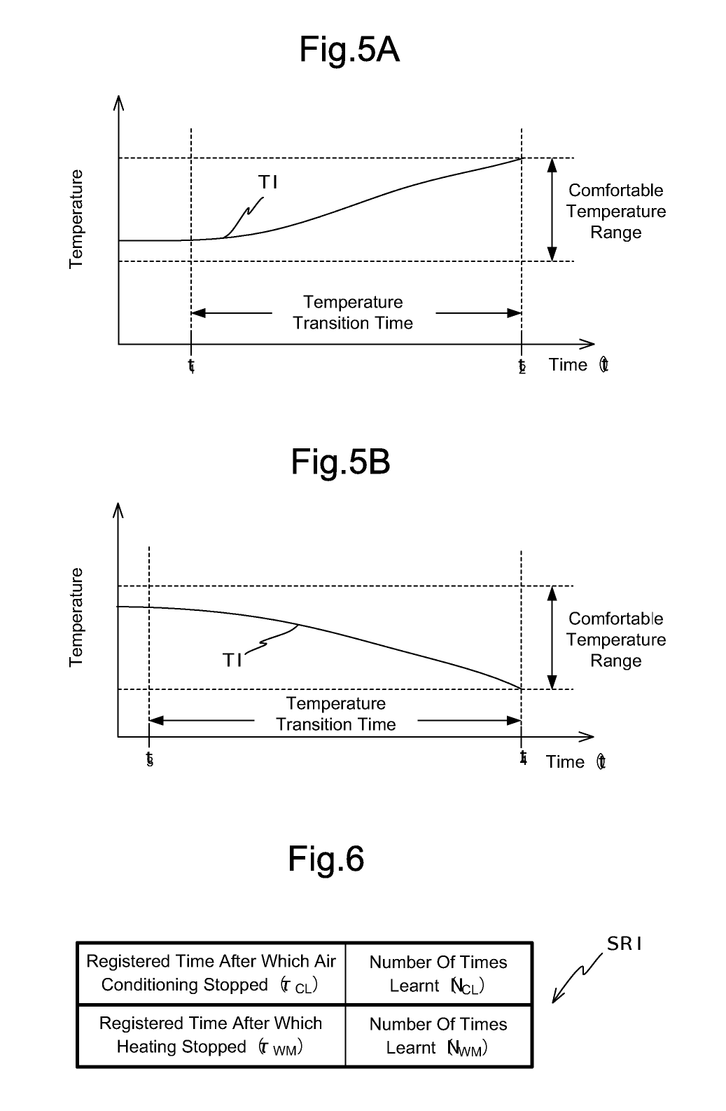

For example, as shown in FIG. 5A, when during the summer the air conditioning device 900, which is operating in the air conditioning operational mode, is stopped at the time instant t₁, the temperature inside the passenger compartment gradually rises in a direction towards deviation from the comfortable temperature range, and at the time instant t₂ it actually deviates from the comfortable temperature range. In this case, the time period (t₂-t₁) is the temperature transition time period.

Furthermore, for example, as shown in FIG. 5B, when during the winter the air conditioning device 900, which is operating in the heating operational mode, is stopped at the time instant t₃, the temperature inside the passenger compartment gradually drops in a direction towards deviation from the comfortable temperature range, and at the time instant t₄ it actually deviates from the comfortable temperature range. In this case, the time period (t₄-t₃) is the temperature transition time period.

For this temperature transition time information described above, it is arranged for such a temperature transition time period to be obtained in advance by experiment, simulation, or the like, for each combination of temperature inside the passenger compartment (TIⱼ (j=1, 2, . . .)) within the predetermined comfortable temperature range at the time point that the air conditioning device 900, which was in operation, is stopped, and temperature external to the passenger compartment (TOₖ (k=1, 2, . . . )) outside the predetermined comfortable temperature range. It should be understood that it is arranged to obtain the temperature transition time periods ttⱼₖ (under the assumption that the temperature TOₖ external to the passenger compartment does not change substantially on the time scale of the temperature transition time period ttⱼₖ.

Returning to FIG. 3, the audio output unit 130 described above comprises a speaker, and outputs audio corresponding to audio data received from the control unit 110. Based upon control by the control unit 110, this audio output unit 130 outputs guidance audio related to navigation processing, such as the direction of progression of the vehicle CR, the travel situation, the traffic situation, and so on.

The display unit 140 described above comprises a display device such as a liquid crystal panel or the like, and displays images corresponding to display data received from the control unit 110. Under the control of the display unit 110, during navigation processing, this display unit 140 displays images such as map information, route information and so on, and also displays guidance information and so on.

The operation input unit 150 described above comprises a key part provided to the main body portion of the navigation device 100, and/or a remote input device that comprises a key part, and so on. Here, a touch panel provided to the display device of the display unit 140 may function as the key part provided to the main body portion. It should be understood that, instead of a structure that includes a key part, or together therewith, there may also be employed a system for voice input using a per se known voice recognition technique.

Upon this operation input unit 150 being operated by the user, settings are made for the navigation device 100 and operation commands are issued. For example, by employing this operation input unit 150, the user may make settings for a destination related to a route found by navigation processing, for temperature adjustment by the air conditioning device 900 within the vehicle passenger compartment, and so on. This type of input contents is sent to the control unit 110 from the operation input unit 150 as operation input data.

The travel information acquisition unit 160 described above comprises an acceleration sensor, an angular velocity sensor, and so on, and detects the acceleration and the angular velocity acting upon the vehicle CR. Furthermore, the travel information acquisition unit 160 acquires speed data, that is the result of detection by the vehicle speed sensor 800 fitted to the vehicle CR. The various data items obtained in this manner are sent to the control unit 110 as traveling data.

The GPS reception unit 170 described above calculates the current position of the vehicle CR on the basis of the result of reception of radio waves from a plurality of GPS satellites. Moreover, this GPS reception unit 170 times the current time instant on the basis of date and time information sent from the GPS satellites. This information related to the current position and the current time instant is sent as GPS data to the control unit 110.

The temperature detection unit 181 described above comprises a first temperature sensor that is disposed in a predetermined position within the vehicle passenger compartment. The temperature inside the passenger compartment detected by this first temperature sensor is sent from the temperature detection unit 181 to the control unit 110.

The temperature detection unit 182 described above comprises a second temperature sensor that is disposed in a predetermined position outside the vehicle passenger compartment. The temperature exterior to the passenger compartment detected by this second temperature sensor is sent from the temperature detection unit 182 to the control unit 110.

It should be understood that, in this example, it is arranged for the second temperature sensor to detect the external air temperature.

Next, the control unit 110 described above will be explained. This control unit 110 comprises a central processing device (CPU) and peripheral circuitry thereof. By executing programs of various types, it is arranged for the control unit 110 to implement functions of various types for the navigation device 100. Among these functions, there are included the functions of the search means 740, the prediction means 750, the first learning means 760, and the control means 770 in the first embodiment described above.

On the basis of the traveling data received from the travel information acquisition unit 160 and the GPS data received from the GPS reception unit 170, the control unit 110 performs processing to supply navigation information to the user while referring as appropriate to the information for navigation in the storage unit 120. In this type of supply processing for navigation information, there are included: (a) map display processing for displaying a map of a region designated by the user upon the display device of the display unit 140; (b) processing for calculating at what position upon the map the vehicle is located and along what azimuth it is facing, and map matching processing for displaying this information upon the display device of the display unit 140, thus presenting it to the user; (c) searching for an optimum route from the position where the vehicle is currently located to a destination point which is designated by the user as desired; (d) calculating a predicted arrival time at the destination for when the vehicle is driven along this set route to the destination; and (e) performing control for giving appropriate advice as to the calculated predicted arrival time and the direction in which the vehicle should be driven, such as performing control for guidance display upon the display device of the display unit 140, performing control for output of audio guidance from the speaker of the audio output unit 130, and so on.

Furthermore, the control unit 110 performs control to operate the air conditioning device 900 in the normal control mode or in the energy saving control mode. Here, the normal control mode or the energy saving control mode is selected according to a control mode selection command to the operation input unit 150 from the passenger.

When the normal control mode is selected, the control unit 110 performs starting control and stop control of the air conditioning device 900 and also control to set the target temperature for regulation, according to orders from the passenger. When the energy saving control mode is selected, in addition to performing control according to settings by the passenger in a similar manner to the case of the normal control mode, the control unit 110 also performs automatic stop control as will be described hereinafter.

Furthermore, when the normal control mode is selected, the control unit 110 performs learning of the time period from the time point that the vehicle CR arrives at its destination or the time point that the vehicle CR stops, to when the air conditioning device 900, which was in operation, is stopped. In this example, it is arranged for this learning to be performed while distinguishing between the time periods after air conditioning is stopped, and the time period after passenger compartment heating is stopped. The result of this learning is utilized in the automatic stop control procedure. The processing related to this learning will be described hereinafter.

It should be understood that, in this example, it is arranged for the result of the above learning to be registered in the control unit 110 as learning result information (SRI) as shown in FIG. 6. In other words, in this example, as the results of this learning, what is registered is a time period τ_{CL} after which the air conditioning stopped, which is the result of learning the time period after which the air conditioning stopped, and the number of times N_{CL} that this learning was performed, and a time period τ_{WM} after which the passenger compartment heating stopped, which is the result of learning the time period after which the passenger compartment heating stopped, and the number of times N_{WM} that this learning was performed.

[Operation]

Next, the operation of the navigation device 100 having the structure described above will be explained, with attention being principally directed to the automatic stop control processing for the air conditioning device 900, during the energy saving control mode.

### <Learning Processing>

First, the learning processing for the time period from the time point that the vehicle CR arrives at its destination or the time point that the vehicle CR stops, to when the air conditioning device 900, which was in operation, is stopped will be explained.

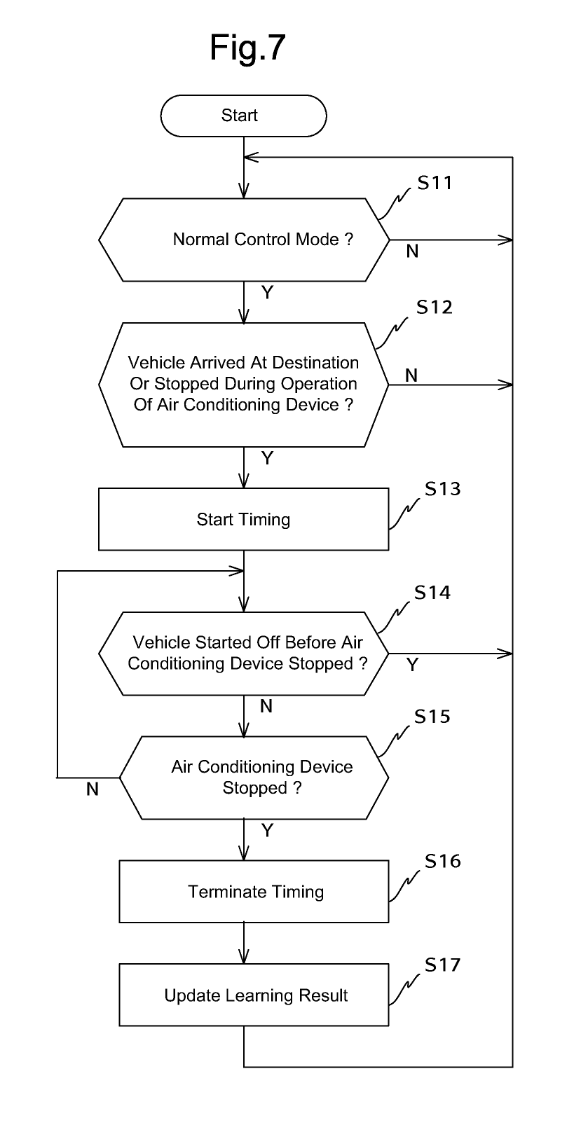

In this learning processing, as shown in FIG. 7, first in a step S11 the control unit 110 makes a judgment as to whether or not the normal control mode is selected. If the result of this judgment is negative (N in the step S11), then the processing of the step S11 is repeated until the result of the judgment in this step S11 becomes affirmative.

When the normal control mode is selected and the result of the judgment in the step S11 becomes affirmative (Y in the step S11), then the flow of control proceeds to a step S12. In this step S12, the control unit 110 makes a judgment as to whether or not, while the air conditioning device 900 is operating, the vehicle CR has arrived at its destination or is stopped.

It should be understood that, in the step S12, it is arranged for the control unit 110 to specify whether the air conditioning device 900 is performing air conditioning operation or is performing passenger compartment heating operation. Furthermore, in this example, it is arranged for the judgment as to whether or not the vehicle has arrived at its destination to be made, if a destination has been set, according to whether or not the vehicle has been stopped at that destination.

If the result of the judgment in the step S12 is negative (N in the step S12), then the flow of control returns to the step S11. The processing of the steps S11 and S12 is repeated until the result of the judgment in this step S12 becomes affirmative.

When, while the normal control mode is selected, the vehicle arrives at its destination or is stopped, so that the result of the judgment in the step S12 becomes affirmative (Y in the step S 12), then the flow of control proceeds to a step S13. In this step S13, the control unit 110 starts timing operation.

Next in a step S14 the control unit 110 makes a judgment as to whether or not, before the air conditioning device 900 is stopped, the vehicle CR has started to move off from rest. If the result of this judgment is affirmative (Y in the step S 14), then the timing operation is terminated, and the flow of control returns to the step S11.

On the other hand, if the result of the judgment in the step S14 is negative (N in the step S14), then the flow of control proceeds to a step S15. In this step S15, the control unit 110 makes a judgment as to whether or not the air conditioning device 900 has been stopped. It should be understood that, in this example, it is arranged for the control unit to determine that the air conditioning device 900 has been stopped when a command issued by the passenger to the control unit 110 has been inputted to the operation input unit 150, or when the accessory power supply has been turned OFF due to operation of the engine key by the passenger.

If the result of the judgment in the step S15 is negative (N in the step S 15), then the flow of control returns to the step S14. On the other hand, if the result of the judgment in the step S15 is affirmative (Y in the step S15), then the flow of control proceeds to a step S16. In this step S16, the control unit 110 terminates the timing operation.

Next, in a step S17, the control unit 110 performs updating processing of the learning result on the basis of the result of this episode of timing. During this updating processing for the learning result, first, on the basis of the operation mode of the air conditioning device 900 specified during the most recent execution of the step S12, the control unit 110 specifies whether, before stopping, the air conditioning device 900 was performing air conditioning operation or was performing passenger compartment heating operation. Next the control unit 110 obtains the timing result for this timing episode by obtaining the elapsed time from the time point that timing was started in the step S13, until the time point that timing was terminated in the step S16.

Next, the control unit 110 updates the learning result corresponding to the operational mode of the air conditioning device 900 before stopping. In other words, if before stopping the air conditioning device 900 was performing air conditioning operation, then the registered time period after stopping air conditioning τ_{CL} and the number of times that learning has been performed N_{CL} in the learning result information (SRI: refer to FIG. 6) described above are updated. Here, the control unit 110 obtains the new registered time period after air conditioning has been stopped by calculating the weighted average value at this time point of the time period after air conditioning has been stopped τ_{CL} and the timing result this time, while taking into account the number of times N_{CL} that learning has been performed. Furthermore, the control unit 110 obtains a new number of times learnt by incrementing the number of times learnt N_{CL} at this time point. The control unit 110 updates the learning result information by registering the new registered time period after air conditioning has been stopped and the new number of times learnt obtained in this manner as the registered time period after air conditioning has been stopped τ_{CL} and the number of times N_{CL}.

On the other hand, if before stopping the air conditioning device 900 was performing passenger compartment heating operation, then the registered time period after stopping passenger compartment heating τ_{WM} and the number of times that learning has been performed N_{WM} in the learning result information described above are updated. This updating is performed in a similar manner to the case when, before stopping, the air conditioning device 900 was performing air conditioning operation, described above.

When the updating of the learning result information in this manner has been completed, the flow of control returns to the step S11. Subsequently the processing of the steps S11 through S17 is repeated, and the learning result information is updated as appropriate.

### <The Automatic Stop Control Procedure>

Next, the automatic stop control procedure will be explained. It should be understood that it will be supposed that the vehicle CR is traveling upon a travel route that has been found in advance.

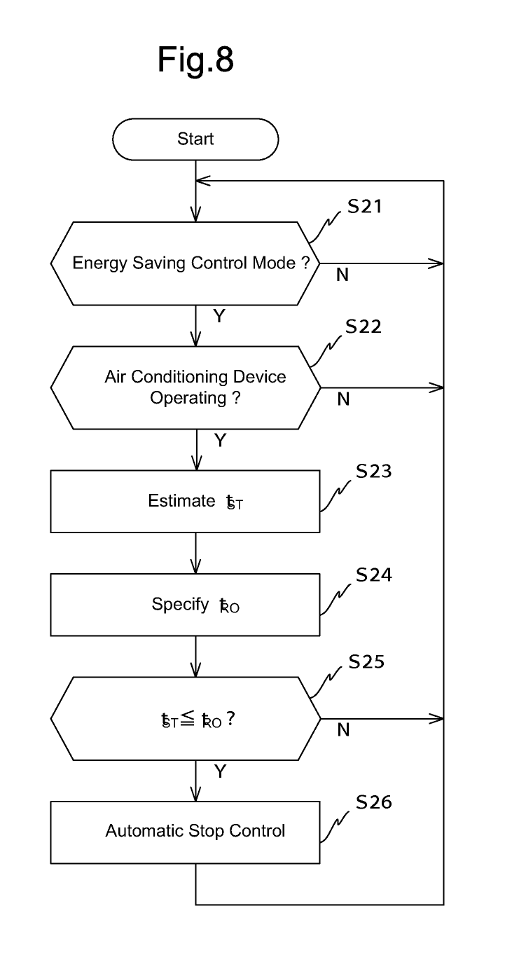

During this automatic stop control procedure, as shown in FIG. 8, first in a step S21 the control unit 110 makes a judgment as to whether or not the energy saving control mode is selected. If the result of this judgment is negative (N in the step S21), then the processing of the step S21 is repeated until the result of this judgment in the step S21 becomes affirmative.

When the energy saving control mode is selected and the result of the judgment in the step S21 becomes affirmative (Y in the step S21), then the flow of control proceeds to a step S22. In this step S22, the control unit 110 makes a judgment as to whether or not the air conditioning device 900 is operating.

If the result of this judgment in the step S22 is negative (N in the step S22), then the flow of control returns to the step S21. The processing of the steps S21 and S22 is repeated until the result of the judgment in this step S22 becomes affirmative. But, when the energy saving control mode is selected and also the air conditioning device 900 is operating, the flow of control proceeds to a step S23.

In the step S23, the control unit 110 estimates the linger period t_{ST} from the present time point until the passengers leave the passenger compartment of the vehicle CR that has arrived at the destination. During this estimation of the linger period t_{ST}, the control unit 110 first obtains a predicted arrival time t_{AR} at the destination on the basis of the route that is being traveled, and while giving consideration to the traveling data received from the travel information acquisition unit 160 and the GPS data received from the GPS reception unit 170. The control unit 110 estimates the linger period t_{ST} on the basis of the time period t_{R} from the present time instant (t_{C}) to the predicted arrival time (t_{AR}), and the learning result described above.

Here, if the air conditioning device 900 is performing air conditioning operation, then the control unit 110 estimates the linger period t_{ST} by calculating the following Equation (1):

t_{ST}=t_{R}τ_{CL} (1)

However, if the air conditioning device 900 is performing passenger compartment heating operation, then the control unit 110 estimates the linger period t_{ST} by calculating the following Equation (2):

t_{ST}=t_{R}τ_{WM} (2)

Next in a step S24 the control unit 110 specifies the divergence period t_{RO}, i.e. the time interval taken for the temperature inside the passenger compartment to deviate from the comfortable temperature range from when the air conditioning device 900 is stopped. During this specification of the divergence period t_{RO}, the control unit 110 acquires the temperature inside the passenger compartment (TIⱼ) detected at the present time point by the temperature detection unit 181 and the temperature external to the passenger compartment (TOₖ) detected by the temperature detection unit 182.

Next, the control unit 110 reads the temperature transition time period tt_{j,k} in the temperature transition time information (TTI (refer to FIG. 4)) described above corresponding to the combination of temperature inside the passenger compartment (TIⱼ) and temperature external to the passenger compartment (TOₖ) that has been acquired. The control unit 110 specifies the temperature transition time period tt_{j,k} that has been read out as being the divergence period t_{RO} at the present time point.

Next in a step S25 the control unit 110 makes a judgment as to whether or not the linger period t_{ST} is less than or equal to the divergence period t_{RO}. If the result of this judgment is negative (N in the step S25), then it is decided that the timing is too early for automatically stopping the air conditioning device 900, and the flow of control returns to the step S21. Subsequently the processing of the steps S21 through S25 is repeated until the result of the judgment in the step S25 becomes affirmative.

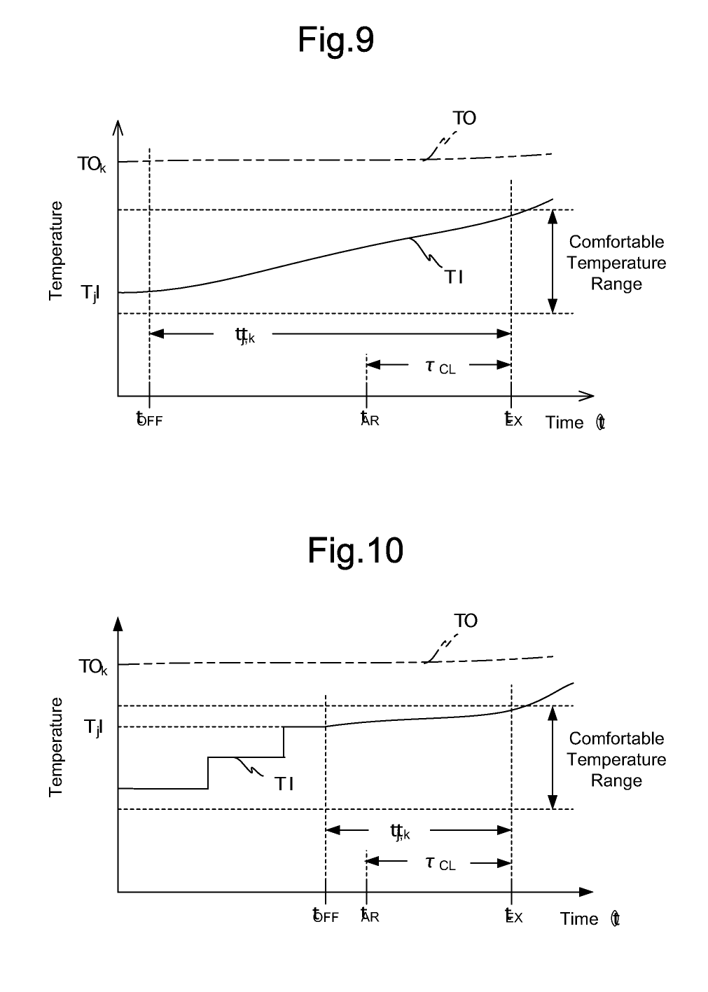

When the result of the judgment in the step S25 becomes affirmative (Y in the step S25), the flow of control proceeds to a step S26. In this step S26, the control unit 110 issues a stop command to the air conditioning device 900. An example of the change over time of the temperature inside the passenger compartment TI from the time instant t_{OFF} that this stop command is issued until the time instant t_{Ex} that the passenger leaves the passenger compartment is shown in FIG. 9 for the case in which air conditioning operation of the air conditioning device 900 has been stopped.

It should be understood that, when the energy saving control mode is selected, in parallel with performing the processing for automatic stop control described above, the control unit 110 also performs starting control and stop control of the air conditioning device 900 according to commands by the passenger, and control to designate a target temperature for adjustment.

As has been explained above, in this example, the predicted arrival time at the destination is obtained on the basis of the travel route that has been found, while taking into consideration the travel information such as the current position of the vehicle CR and the driving speed and so on. Moreover, in the normal control mode, the time period from the time point that the vehicle CR arrives at its destination or the time point that the vehicle CR stops, to when the air conditioning device 900, which was in operation, is stopped is learnt.

In the energy saving control mode, on the basis of this predicted arrival time and the result of the above learning, the linger period from the present time point until the passengers leave the passenger compartment of the vehicle CR that has arrived at the destination is estimated. Furthermore, on the basis of the temperature inside the passenger compartment detected by the temperature detection unit 181 and the temperature external to the passenger compartment detected by the temperature detection unit 182, and on the basis of the temperature transition time information (TTI) stored in the storage unit 120, the divergence time period from when the operation of the air conditioning device 900 is stopped, in other words the time interval taken for the temperature inside the passenger compartment to deviate from the comfortable temperature range, is specified. Automatic stop control is performed and the operation of the air conditioning device 900 is stopped at the time point that it has been decided that the above linger period has become less than or equal to the above divergence period.

Thus, according to this example, it is possible to reduce the amount of electrical power consumed by the air conditioning device, while still maintaining the comfort within the vehicle passenger compartment.

Moreover, in this example, it is distinguished whether air conditioning or passenger compartment heating is being performed, and learning is performed of the time period from the time point that the vehicle CR arrives at its destination or the time point that the vehicle CR stops, to when the air conditioning device 900, which was in operation, is stopped. By doing this, it is possible to learn the linger period after arrival at the destination of a passenger within the vehicle passenger compartment of the vehicle CR, while reflecting the individual preference of the passenger for warmth or coolness.

### Modification of the Embodiment

The present invention is not to be considered as being limited to the examples described above; variations of various types may be made therein.

For example, in the example described above, it is arranged to perform automatic stop control for the air conditioning device 900 when the linger period t_{ST} has become less than or equal to the divergence period t_{RO} during operation of the air conditioning device 900 for temperature adjustment according to commands from the passenger. By contrast, before this automatic stop control, it would also be acceptable to arrange to perform setting adjustment of the temperature inside the passenger compartment by the air conditioning device 900 stepwise within the comfortable temperature range along the direction of change of the temperature inside the passenger compartment when the air conditioning device 900 is stopped. An example in this case of the change over time of the temperature inside the passenger compartment TI up to the time instant t_{Ex} at which the passenger leaves the passenger compartment is shown in FIG. 10 for the case when the air conditioning operation of the air conditioning device 900 has been stopped. It should be understood that the designation of time instants in FIG. 10 is similar to the designation of time instants in FIG. 9 described above.

The comfortable temperature range in the example described above may be set to different ranges in the case of air conditioning and in the case of passenger compartment heating. For example, as disclosed as a result of research and experiment in many prior art documents and so on, the comfortable temperature range in the case of air conditioning may be considered as being 24° C. to 28° C., while the comfortable temperature range in the case of passenger compartment heating may be considered as being 18° C. to 23° C.

Moreover, in the example described above, it was arranged to perform learning of the time period from the time point that the vehicle CR arrives at its destination or the time point that the vehicle CR stops, to when the air conditioning device 900, which was in operation, is stopped while distinguishing the case of air conditioning from the case of passenger compartment heating. By contrast, it would also be possible to perform this learning for each temperature external to the passenger compartment at the time point that the air conditioning device 900 is stopped. In this case, it is possible to perform learning of the linger period of the passenger within the vehicle passenger compartment after arrival at the destination in which the tendency of individual behavior of the passenger in the vehicle CR corresponding to the difference between the temperature external to the passenger compartment and a comfortable temperature is reflected.

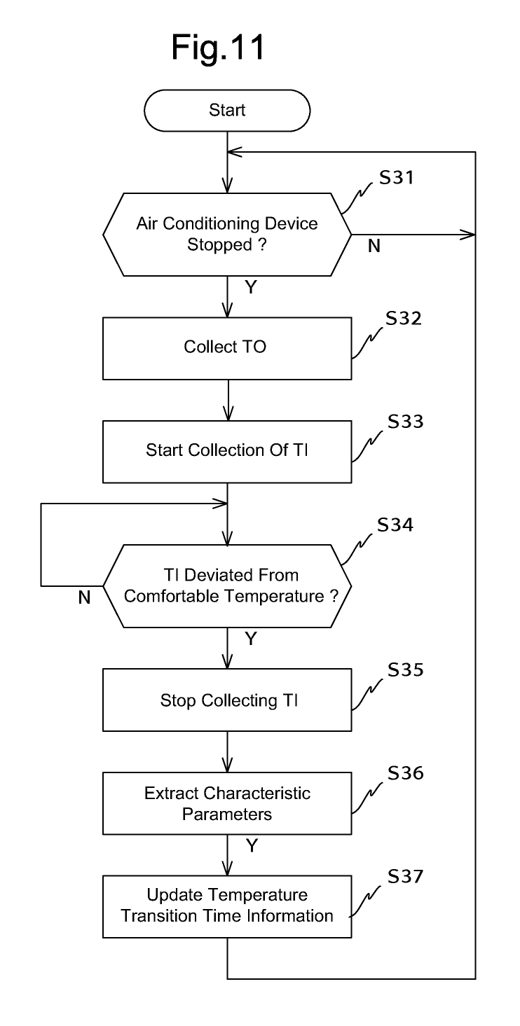

Furthermore, in the example described above, although in the first embodiment there was only one version of the temperature transition time information, it is also possible to arrange to perform updating thereof, as in the second embodiment. An example of this type of updating processing will now be explained with reference to FIG. 11. It should be understood that, in this variant example, the control unit 110 described above also fulfils the function of the second learning means 780.

In this updating processing, first in a step S31 the control unit 110 makes a judgment as to whether or not the air conditioning device 900 has been stopped, irrespective of whether the system is operating in the normal control mode or in the energy saving control mode. If the result of this judgment is negative (N in the step S31), the processing of this step S31 is repeated.

But if the air conditioning device 900 is stopped so that the result of the judgment in the step S31 is affirmative (Y in the step S31), then the flow of control proceeds to a step S32. In this step S32, the control unit 110 collects the temperature TO external to the passenger compartment that is being detected by the temperature detection unit 182 at this time point.

Next, in a step S33, the control unit 110 starts the operation of collecting the temperature TI inside the passenger compartment detected by the temperature detection unit 181. It should be understood that this collection of the temperature inside the passenger compartment by the above collection operation is performed periodically until the collection operation is terminated in a step S35 that will be described hereinafter.

Next in a step S34 a judgment is made as to whether or not the temperature TI inside the passenger compartment has deviated from the comfortable temperature range. If the result of this judgment is negative (N in the step S34), then the processing of the step S34 is repeated.

But when the temperature TI inside the passenger compartment has deviated from the comfortable temperature range and the result of the judgment in the step S34 becomes affirmative (Y in the step S34), the flow of control proceeds to a step S35. In this step S35, the control unit 110 terminates the operation of collecting the temperature TI inside the passenger compartment.

Next, in this step S36, on the basis of the results of collection of the temperature external to the passenger compartment this time and the temperature inside the passenger compartment, the control unit 110 extracts the characteristic parameters of change of the temperature inside the passenger compartment after the air conditioning device 900 has stopped, corresponding to combinations of the temperature external to the passenger compartment and the temperature inside the passenger compartment when the air conditioning device 900 is stopped. On the basis of the characteristic parameters extracted this time and the characteristic parameters that are registered internally to the control unit 110 at this time point, the control unit 110 calculates new characteristic parameters by, for example, calculating a weighted average value thereof, and registers this internally. As a result, the characteristic parameters registered internally to the control unit 110 are updated.

Next, in a step S37, the control unit 110 calculates new temperature transition time information by utilizing these new characteristic parameters. The control unit 110 registers this new temperature transition time information (TTI) in the storage unit 120. As a result, the temperature transition time information in the storage unit 120 is updated.

It should be understood that while, in the example and variant examples described above, it is arranged to implement the functions of various means, except for those of the storage means and the first and second temperature detection means, by executing a program with a computer, it would also be acceptable to arrange to construct all or some of these various means with hardware using a dedicated LSI (Large Scale Integrated circuit) or the like.

1-11. (canceled)

12. An air conditioning control device, mounted to a vehicle, which controls the operation of an air conditioning device that regulates the temperature inside a passenger compartment comprising:
a first temperature detection means that detects said temperature inside the passenger compartment;
a second temperature detection means that detects the temperature external to the passenger compartment of said vehicle;
a prediction means that obtains a predicted arrival time of said vehicle at a destination;
a storage means that stores temperature transition time information consisting of the time period required until said temperature inside the passenger compartment deviates from a predetermined comfortable temperature range, corresponding to the temperature inside the passenger compartment and the temperature external to the passenger compartment when said air conditioning device is stopped; and
a control means that performs automatic stop control to stop said air conditioning device, at the time point that it is decided that said temperature inside the passenger compartment will not deviate from said comfortable temperature range even if said air conditioning device is stopped, over an interval that it is estimated that a passenger will remain within the passenger compartment of said vehicle, while taking into consideration said predicted arrival time, said temperature inside the passenger compartment, said temperature external to the passenger compartment, and said temperature transition time information.

13. An air conditioning control device according to claim 12, wherein that said temperature external to the passenger compartment is the external air temperature.

14. An air conditioning control device according to claim 12, further comprising a first learning means that, when said automatic stop control is not being performed by said control means, learns the time period from the time point that said vehicle arrives at its destination or stops, to when said air conditioning device, which was operating, stops; and
said control means performs said automatic stop control in further consideration of the result of learning by said first learning means.

15. An air conditioning control device according to claim 14, wherein said first learning means performs said learning while distinguishing between the case in which said air conditioning device is performing air conditioning operation, and the case in which said air conditioning device is performing passenger compartment heating operation.

16. An air conditioning control device according to claim 14, wherein said first learning means performs said learning for each temperature external to the passenger compartment detected by said second temperature detection means.

17. An air conditioning control device according to claim 12, further comprising a second learning means that learns the relationship between said temperature inside the passenger compartment and said temperature external to the passenger compartment after said air conditioning device has stopped, and that updates said temperature transition time information on the basis of the result of learning.

18. An air conditioning control device according to claim 12, wherein, before said automatic stop control, said control means performs setting of the regulation of said temperature inside the passenger compartment by said air conditioning device stepwise within said comfortable temperature range along the direction of change of said temperature inside the passenger compartment when said air conditioning device has been stopped.

19. An air conditioning control device according to claim 12, further comprising a search means that finds a travel route to said destination; and
said prediction means obtains said predicted arrival time on the basis of said travel route that has been found.

20. An air conditioning control method employed by an air conditioning control device that is mounted to a vehicle, and that controls the operation of an air conditioning device that regulates the temperature inside a passenger compartment comprising:
a temperature detection process of detecting said temperature inside the passenger compartment and the temperature external to the passenger compartment of said vehicle;
a prediction process, performed in parallel with said temperature detection process, of obtaining a predicted arrival time of said vehicle at a destination; and
an automatic stop control process of stopping the operation of said air conditioning device, at the time point that it is decided that said temperature inside the passenger compartment will not deviate from said comfortable temperature range even if said air conditioning device is stopped, over an interval that it is estimated that a passenger will remain within the passenger compartment of said vehicle, while taking into consideration said predicted arrival time, said temperature inside the passenger compartment and said temperature external to the passenger compartment, and temperature transition time information consisting of the time period required until said temperature inside the passenger compartment deviates from a predetermined comfortable temperature range, stored in a storage means provide to said air conditioning control device, and corresponding to the temperature inside the passenger compartment and the temperature external to the passenger compartment when said air conditioning device is stopped.

21. An air conditioning control program, wherein it causes a calculation means to execute an air conditioning control method as described in claim 20.

22. A recording medium, wherein an air conditioning control program as described in claim 21 is recorded thereupon so as to be readable by a calculation means.

23. An air conditioning control device according to claim 13, further comprising a first learning means that, when said automatic stop control is not being performed by said control means, learns the time period from the time point that said vehicle arrives at its destination or stops, to when said air conditioning device, which was operating, stops; and
said control means performs said automatic stop control in further consideration of the result of learning by said first learning means.

24. An air conditioning control device according to claim 13, further comprising a second learning means that learns the relationship between said temperature inside the passenger compartment and said temperature external to the passenger compartment after said air conditioning device has stopped, and that updates said temperature transition time information on the basis of the result of learning.

25. An air conditioning control device according to claim 14, further comprising a second learning means that learns the relationship between said temperature inside the passenger compartment and said temperature external to the passenger compartment after said air conditioning device has stopped, and that updates said temperature transition time information on the basis of the result of learning.

26. An air conditioning control device according to claim 15, further comprising a second learning means that learns the relationship between said temperature inside the passenger compartment and said temperature external to the passenger compartment after said air conditioning device has stopped, and that updates said temperature transition time information on the basis of the result of learning.

27. An air conditioning control device according to claim 16, further comprising a second learning means that learns the relationship between said temperature inside the passenger compartment and said temperature external to the passenger compartment after said air conditioning device has stopped, and that updates said temperature transition time information on the basis of the result of learning.

28. An air conditioning control device according to claim 13, wherein, before said automatic stop control, said control means performs setting of the regulation of said temperature inside the passenger compartment by said air conditioning device stepwise within said comfortable temperature range along the direction of change of said temperature inside the passenger compartment when said air conditioning device has been stopped.

29. An air conditioning control device according to claim 14, wherein, before said automatic stop control, said control means performs setting of the regulation of said temperature inside the passenger compartment by said air conditioning device stepwise within said comfortable temperature range along the direction of change of said temperature inside the passenger compartment when said air conditioning device has been stopped.

30. An air conditioning control device according to claim 15, wherein, before said automatic stop control, said control means performs setting of the regulation of said temperature inside the passenger compartment by said air conditioning device stepwise within said comfortable temperature range along the direction of change of said temperature inside the passenger compartment when said air conditioning device has been stopped.

31. An air conditioning control device according to claim 16, wherein, before said automatic stop control, said control means performs setting of the regulation of said temperature inside the passenger compartment by said air conditioning device stepwise within said comfortable temperature range along the direction of change of said temperature inside the passenger compartment when said air conditioning device has been stopped.
